(19) United States
(12) Patent Application Publication
(10) Pub. No.: US 2015/0192824 A1
(43) Pub. Date: Jul. 9, 2015

(54) DISPLAY DEVICE AND TELEVISION RECEPTION DEVICE

(71) Applicant: Sharp Kabushiki Kaisha, Osaka (JP)

(72) Inventor: Eiji Hirota, Osaka (JP)

(73) Assignee: Sharp Kabushiki Kaisha, Osaka (JP)

(21) Appl. No.: 14/416,019

(22) PCT Filed: Jul. 19, 2013
(86) PCT No.: PCT/JP2013/069603

§ 371 Date: Jan. 20, 2015

(30) Foreign Application Priority Data
Jul. 26, 2012 (JP) 2012-165529

(51) Int. Cl. G02F 1/1333; H04N 5/44; F21V 8/00

(52) U.S. Cl. CPC G02F 1/133308; G02B 6/005; G02B 6/0088; H04N 5/44; G02F 2001/133314; G02F 2001/133317

(57) ABSTRACT

This liquid crystal display device is provided with a support member having: a first support section that has a first support surface at which the edge of an optical member is supported; a second support section provided to the liquid crystal panel side of the first support section and having a second support surface at which the edge of the liquid crystal panel is supported; and a recessed section that is provided between the first support section and the second support section, is configured from the first support surface and the reverse surface at the reverse side from the second support surface, and is such that the edge of the optical member can enter the interior thereof. By means of the reverse surface being an inclined surface that is inclined with respect to the second support surface, the thickness of the second support section is caused to become greater with distance from the edge of the liquid crystal panel.

### TECHNICAL FIELD

The present invention relates to a display device and a television receiver.

### BACKGROUND ART

Liquid crystal display devices such as liquid crystal televisions have a liquid crystal panel, which is a display panel that does not emit light, and therefore, it is necessary to separately provide a backlight device as an illumination device, for example. Depending on the mechanism thereof, the backlight devices of this type of liquid crystal display device are largely divided into direct-lit types and edge-lit types. Both direct-lit type and edge-lit type backlight devices have sheet-shaped optical members having the function of converting the light emitted from the light source into planar light disposed between the liquid crystal panel and the backlight device. A display device having a panel holder that supports this type of optical members and a liquid crystal panel is disclosed in Patent Document 1, for example.

### RELATED ART DOCUMENT

### Patent Document

Patent Document 1: Japanese Patent Application Laid-Open Publication No. 2006-235425

### Problems to be Solved by the Invention

In display devices such as those in Patent Document 1, in some cases, the optical members expand due to heat from the light source, and edges of the optical members extend outward (away from the center of the backlight device). In this case, if the edge of the expanded optical member hits the support member of the panel holder or the like, then the expansion of the optical member cannot be further accommodated, and in some occasions wrinkles can form in the vicinity of the edge of the optical member. If this type of wrinkling occurs, the function of the optical member deteriorates, and the display quality of the display panel decreases.

As a countermeasure, the problem above can be solved by providing a housing space in which the portion of the optical members that has expanded due to heat can be accommodated, but if this type of housing space is provided, this causes a decrease in strength in the vicinity of the portion of the support member, and as a result, there is a risk that the support member cannot function as a support member.

### SUMMARY OF THE INVENTION

The technology disclosed in the present specification was made in view of the above-mentioned problems. An object of the techniques disclosed in the present specification is to maintain the strength of the support member while accommodating the optical member expanding due to heat in a configuration having a support member that supports the display panel and the optical member.

### Means for Solving the Problems

The technology disclosed in the present specification relates to a display device having: a light source; a display panel that performs display using light from the light source; an optical member having a sheet shape disposed to a side of the display panel opposite to the display surface thereof that performs the display; a chassis that at least has a plate-shaped portion and that is disposed to a side of the optical member opposite to a side thereof opposing the display panel; and a support member that supports the display panel and the optical member, the support member including a first support section having a first support surface that supports an edge of the optical member, a second support section that is disposed closer to the display panel than the first support section, the second support section having a second support surface that supports an edge of the display panel, and a recess that is provided between the first support section and the second support section, the recess being formed between the first support surface and an opposite surface that is opposite to the second support surface so that an edge of the optical member can enter the recess, wherein the opposite surface is an inclined surface that is inclined with respect to the second support surface such that a thickness of the second support section increases as a distance from the edge of the display panel increases.

According to the display device mentioned above, if the edge of the optical member extend in a direction away from the center of the optical member due to heat, then the extended portion is accommodated by the recess without colliding with the support member. At this time, because the opposite surface of the second support section is an inclined surface, if the extending portion extends further after coming into contact with the inclined surface, then the extending portion is guided further inside the recess along the inclined surface. As a result, even if the edge of the optical member extends, the extension can be accommodated, and therefore wrinkles can be prevented or suppressed in the edge of the optical member. Furthermore, because the opposite surface of the second support section is an inclined surface, the thickness of the first support section increases as the first support section is farther away from the edge of the display panel. Therefore, in comparison to a case in which a recess is provided such that the thickness of the second support section is constant, the strength of the second support section is improved. Thus, even if a recess is provided between the first support section and the second support section, the strength of the second support section can be maintained. The display device mentioned above, which has a configuration in which a support member supports the display panel and the optical member, can maintain the strength of the support member while accommodating the optical member expanding due to heat.

The inclined surface may have a curved shape that is recessed towards the second support surface.

According to this configuration, by having the extended portion of the optical member come into contact with the curved inclined surface, the portion can enter farther inside the recess more smoothly. As a result, the extending of the optical member due to heat can be effectively accommodated.

A small flat surface may be formed on the tip of the second support section along a direction perpendicular to the display surface of the display panel.

According to this configuration, the tip of the second support section is not pointed because a flat face is provided on the tip of the second support section, and thus, the thickness of the tip of the second support section can be made greater compared to a configuration in which the tip of the second support section is pointed. As a result, the strength of the tip of the second support section can be increased compared to a configuration in which the tip of the second support section is pointed.

The display panel and the optical member may respectively have a rectangular shape in a plan view, and the support member may be at least provided on each side of prescribed two edges of the optical member opposing each other.

According to this, the display panel and the optical member can be effectively supported by the respective support members.

The support member may be disposed on each side of edges of the display panel.

According to this configuration, the display panel and the optical member can be more effectively supported by the four support members.

The display panel may be slightly larger than the optical member in a plan view.

According to this configuration, the second support section is provided farther outside than the first support section (farther away from the center of the display panel), and a detailed configuration of the support member having a level difference between the first support section and the second support section can be provided.

The optical member may include a plurality of sheet members stacked one on top of another, and a sheet member having a greatest thermal expansion coefficient among the plurality of sheet members may be disposed closest to the display panel.

According to this configuration, if edges of the optical members extend due to heat, then the frontmost sheet among the sheet members constituting the optical members, which has the greatest effect on display quality if it is wrinkled, comes into contact with the inclined surface in the recess first, and thus, the frontmost sheet member can be guided towards the end of the recess, thereby preventing deterioration or the like in the display quality due to wrinkles forming in the optical members.

The chassis may have a side wall that rises from an edge of the chassis towards the display surface, and the support member may be supported by the chassis by a surface of the first support section opposite to the first support surface being in contact with a tip of the side wall towards the display surface.

According to this, a specific configuration in which the support member is attached to the chassis can be provided.

According to the techniques disclosed in the present specification, a display device that uses a liquid crystal panel as the display panel is novel and useful. A television receiver that includes the above-mentioned display device is also novel and useful.

### Effects of the Invention

According to the techniques disclosed in the present specification, in a configuration that includes a support member that individually supports the display panel and the optical member, the strength of the portion supporting the display panel can be maintained while accommodating the extension of the optical member resulting from heat.

### BRIEF DESCRIPTION OF THE DRAWINGS

FIG. 1 is an exploded perspective view showing a schematic configuration of a television receiver TV and a liquid crystal display unit LDU of Embodiment 1.

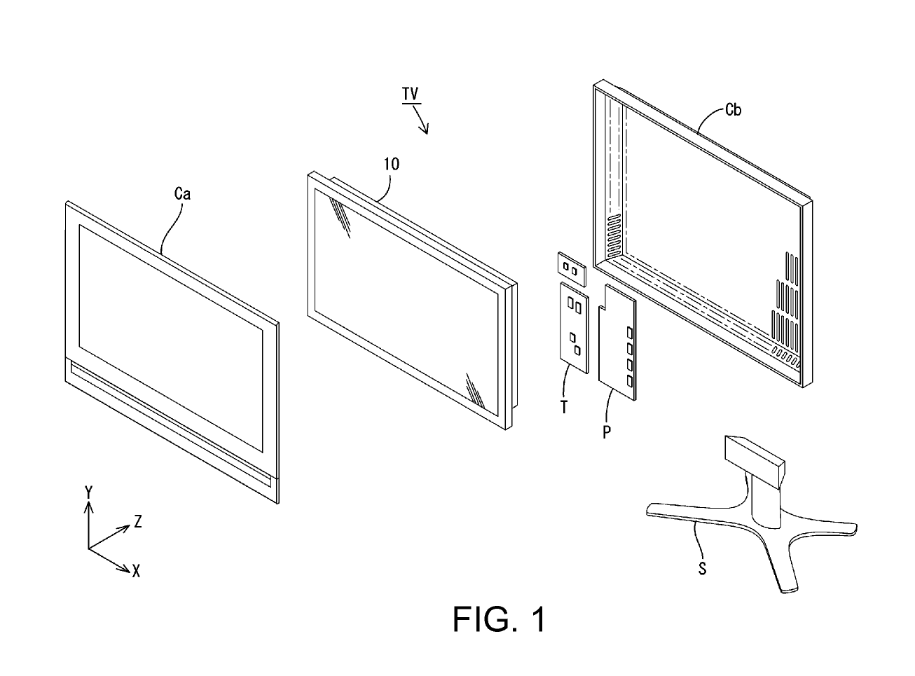

FIG. 2 is an exploded perspective view of a liquid crystal display device 10.

FIG. 3 is a cross-sectional view of a configuration of the liquid crystal display device 10 along the shorter side direction.

FIG. 4 is a perspective view of a holding member 30.

FIG. 5 is a cross-sectional view of main components of the liquid crystal display device 10 in which the vicinity of one of the holding members 30 is magnified.

FIG. 6 is a cross-sectional view of main components of a liquid crystal display device 110 in which the vicinity of a holding member 130 of Embodiment 2 is magnified.

FIG. 7 is a cross-sectional view of main components of a liquid crystal display device 210 in which the vicinity of a holding member 230 of Embodiment 3 is magnified.

FIG. 8 is an exploded perspective view schematically showing a liquid crystal display device 310 according to Embodiment 4 of the present invention.

FIG. 9 is a cross-sectional view that shows a cross-sectional configuration of the liquid crystal display device 310 along the longer side direction.

FIG. 10 is a cross-sectional view of main components of the liquid crystal display device 310 in which the vicinity of one of the holding members 330 in FIG. 9 is magnified.

### DETAILED DESCRIPTION OF EMBODIMENTS

### Embodiment 1

Embodiment 1 will be described with reference to the drawings. In the present embodiment, a liquid crystal display device (an example of a display device) 10 will be described as an example. Each of the drawings indicates an X axis, a Y axis, and a Z axis in a portion of the drawings, and each of the axes indicates the same direction for the respective drawings. The Y axis direction corresponds to the vertical direction and the X axis direction corresponds to the horizontal direction. Unless otherwise noted, “up” and “down” in the description is based on the vertical direction.

A television receiver TV includes a liquid crystal display device 10, front and rear cabinets Ca and Cb that house the liquid crystal display device 10 therebetween, a power source P, a tuner T, and a stand S. The liquid crystal display unit LDU has a horizontally-long quadrilateral shape as a whole, and includes a liquid crystal panel 11, which is a display panel, and a backlight device (an example of an illumination device) 12, which is an external light source. These are integrally held together by a bezel 13 or the like, which is an external member that constitutes the exterior of the liquid crystal display device 10.

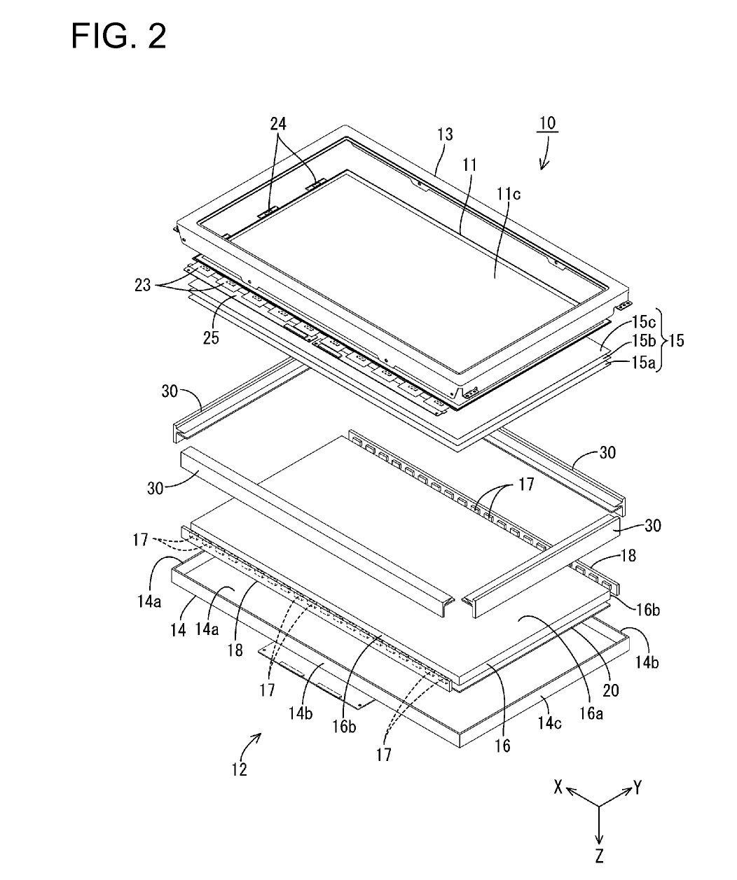

As shown in FIG. 2, the main constituting components of the liquid crystal display device 10 are housed in a space between the bezel 13 that constitutes the front exterior of the liquid crystal display device 10, and the chassis 14 that constitutes the rear exterior. The main constituting components housed in the bezel 13 and the chassis 14 at least include the liquid crystal panel 11, the optical members 15, the support member 30, the light guide plate 16, and an LED substrate 18. Of these, the liquid crystal panel 11, optical members 15, and the light guide plate 16 are alternately stacked one on top of the other, and the liquid crystal panel 11 and the optical members 15 are supported by the support member 30. The backlight device 12 includes the optical members 15, the support member 30, the light guide plate 16, the LED substrate 18, and the chassis 14, and the configuration excludes the liquid crystal panel 11 and the bezel 13 from the liquid crystal display device 10 mentioned above. The LED substrates 18, which are a part of the backlight device 12, are disposed between the bezel 13 and the chassis 14 so as to face both edge faces along the long side of the light guide plate 16. The respective constituting components will be explained below.

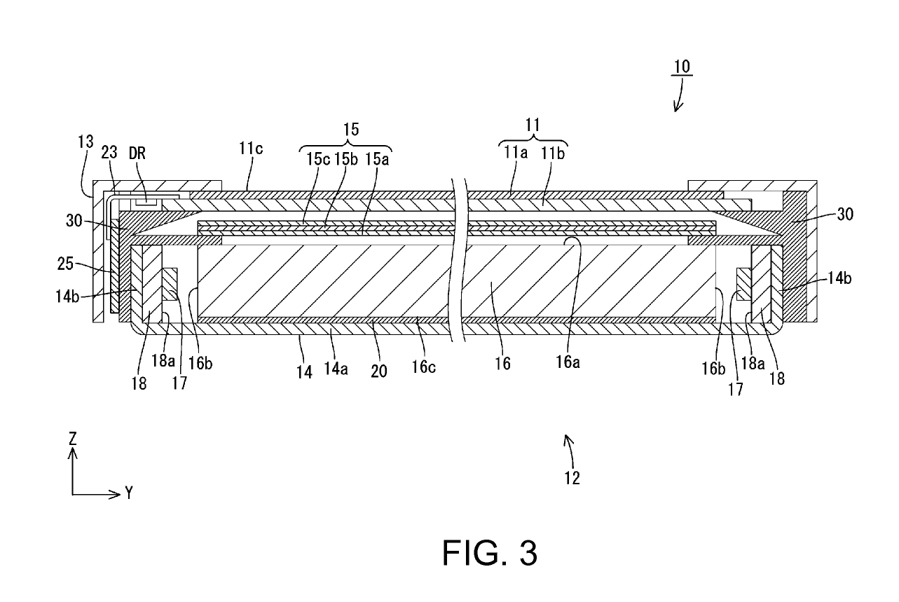

As shown in FIG. 3, the liquid crystal panel 11 is formed in a horizontally long quadrilateral shape (rectangular shape) in a plan view, and is configured by bonding a pair of glass substrates 11a and 11b (see FIG. 3) having high light transmittance to each other with a prescribed gap therebetween, and sealing liquid crystal between the two substrates 11a and 11b. On one of the substrates (the array substrate) 11b, switching elements (TFTs, for example) connected to source wiring lines and gate wiring lines that intersect with each other, pixel electrodes connected to the switching elements, an alignment film, and the like are provided. On the other substrate (CF substrate) 11a, color filters having colored portions such as R (red), G (green), and B (blue) arranged in prescribed arrays, an opposite electrode, an alignment film, and the like are provided. This liquid crystal panel 11 is disposed so as to oppose the front side of the optical members 15 mentioned later, and the liquid crystal panel 11 and the optical members 15 are separated by a small gap provided therebetween. The display surface 11c of the liquid crystal panel 11 is constituted of a display region that is in the center of the screen and that can display images, and a non-display region that is in the outer edges of the screen and that is formed in a frame shape surrounding the display region. This liquid crystal panel 11 is connected to a control substrate through a driver component for driving liquid crystal and a flexible substrate 23, and the liquid crystal panel 11 is configured to display images on the display region of the display surface 11c based on signals inputted from the control substrate 25. Polarizing plates (not shown) are respectively provided on outer sides of the two substrates 11a and 11b.

As shown in FIG. 2, the optical members 15 have a horizontally-long quadrilateral shape in a plan view similar to the liquid crystal panel 11, and the size thereof (short side dimensions and long side dimensions) is slightly smaller in comparison to that of the liquid crystal panel 11. In other words, the liquid crystal panel 11 is slightly larger than the optical members 15 in a plan view. The optical members 15 are supported by the first supporting surface of the support member mentioned later so as to face the surface of the light guide plate (light-emitting surface 16a) mentioned later. There are three sheet-shaped optical members 15 stacked one on top of the other. Specifically, the optical members 15 are constituted of a diffusion sheet 15a, a lens sheet (prism sheet) 15b, and a reflective polarizing sheet 15c, in that order starting from the rear side (the side with the light guide plate 16). The size of the respective three sheets 15a, 15b, and 15c is approximately the same in a plan view. Furthermore, among the three sheets that constitute the optical members 15, the reflective polarizing sheet 15c, which is disposed farthest towards the front, has the greatest thermal expansion coefficient.

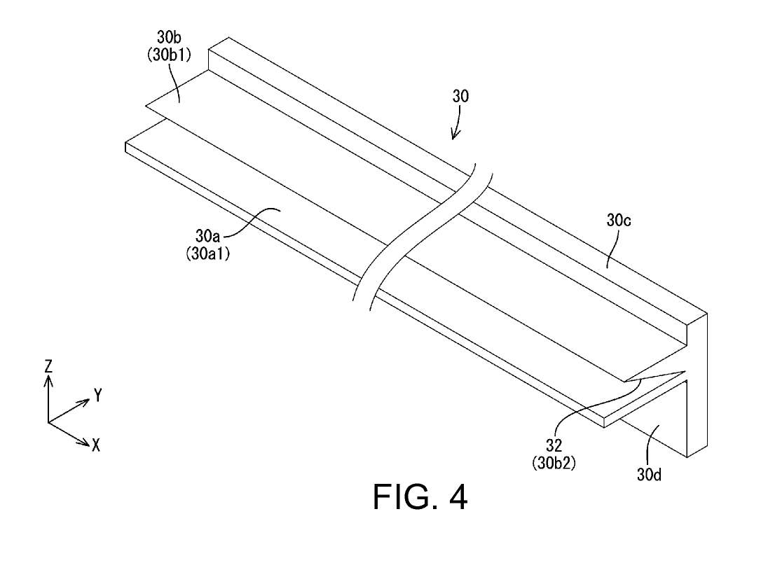

The light guide plate 16 is made of a synthetic resin (an acrylic resin such as PMMA or a polycarbonate, for example) with a higher refractive index than air and is almost completely transparent (excellent light transmission). As shown in FIG. 2, the light guide plate 16 has a horizontally-long quadrilateral shape in a plan view, in a manner similar to the liquid crystal panel 11 and the optical members 15, and has a plate shape that is thicker than the optical members 15. The long side direction on the main surface of the light guide plate 16 corresponds to the X axis direction, the short side corresponds to the Y axis direction, and the plate thickness direction intersecting with the main surface corresponds to the Z axis direction. The light guide plate 16 opposes the rear surface of the optical members 15 and is sandwiched between a first support section 30a of the support member 30 and the chassis 14. As shown in FIG. 4, the light guide plate 16 at least has larger short side dimensions than the respective short side dimensions of the liquid crystal panel 11 and the optical members 15, and the light guide plate 16 is disposed such that respective edges of the short side direction (respective edges along the long side direction) match the respective edges of the short side direction of the liquid crystal panel 11 and the optical members 15. Both long side faces (light-receiving faces 16b) of this light guide plate 16 face the LED substrates 18, and light from the LEDs 17 enter both long side faces. The light guide plate 16 has the function of guiding therethrough light from the LEDs 17 that entered from the respective edges facing each other in the short side direction, internally propagating this light, and emitting the light toward the optical members 15 (front side).

Of the main surfaces of the light guide plate 16, the surface facing the front side (facing the optical members 15) is a light-emitting surface 16a where internal light exits towards the optical members 15 and the liquid crystal panel 11. Of the two peripheral end faces adjacent to the main surface of the light guide plate 16, both end faces of the light guide plate 16 in the long side direction along the X axis are light-receiving faces 16b that directly face the respective LEDs 17 (LED substrates 18) with a prescribed gap therebetween and that receive light emitted from the LEDs 17. As shown in FIG. 4, a reflective sheet 20 is provided on the rear side of the light guide plate 16, or namely, on a surface 16c opposite to the light-emitting surface 16a (the surface facing the chassis 14). This reflective sheet 20 covers almost the entire surface 16c.

The reflective sheet 20 is disposed so as to be sandwiched between the chassis 14 and the light guide plate 16 and can reflect light that exits from the rear side back towards the front side. The reflective sheet 20 is made of a synthetic resin, and the surface thereof has a highly reflective white color. The short side dimension of the reflective sheet 20 is substantially equal to the short side dimension of the light guide plate 16, and both edges of the reflective sheet 20 are positioned so as to match the light-receiving faces 16b of the light guide plate 16.

The LEDs 17 have a configuration in which an LED chip is sealed with a resin on a substrate part that is affixed to the LED substrate 18. The LED chip mounted on the substrate part has one type of primary light emitting wavelength, and specifically, only emits blue light. On the other hand, the resin that seals the LED chip has a fluorescent material dispersed therein, the fluorescent material emitting light of a prescribed color by being excited by the blue light emitted from the LED chip. This combination of light from the LED chip and the fluorescent material causes white light to be emitted overall. As the fluorescent material, a yellow fluorescent material that emits yellow light, a green fluorescent material that emits green light, and a red fluorescent material that emits red light, for example, can be appropriately combined, or one of them can be used on its own. Each of the LEDs 17 is of a so-called top-emitting type in which the side opposite to that mounted onto the LED substrate 18 (side facing the light-receiving face 16b of the light guide plate 16) is the primary light-emitting surface.

As shown in FIG. 2, the LED substrates 18 are each formed in a narrow plate shape that extends along the longer side direction (X axis direction) and are housed between the frame 13 and the chassis 14 such that each surface thereof is parallel to the X axis direction and the Z axis direction, or in other words, in parallel with the light-receiving faces 16b of the light guide plate 16. On the inner surfaces of the respective LED substrates 18, or in other words, on the surfaces facing the light guide plate 16 (surfaces facing the light guide plate 16; hereinafter, mounting surfaces 18a), and the LEDs 17 having the above-mentioned configuration are mounted onto the mounting surfaces 18a. Each of the LEDs 17 is disposed on the mounting surface of the LED substrate 18 so as to be aligned along the lengthwise direction (X axis direction) with a prescribed gap between adjacent LEDs 17, and the optical axis thereof substantially matches the Y axis direction. On the other hand, the surface of the LED substrate 18 opposite the mounting surface 18a thereof is in contact with a side wall 14b of the chassis 14 and is attached to the side wall 14b by screws or the like. The base member of the LED substrate 18 is made of a metal such as aluminum, for example, and a wiring pattern (not shown) made of metal film is formed over the surface across an insulating layer. The base material of the LED substrate 18 can alternatively be formed of an insulating material such as a ceramic.

As shown in FIG. 2, the chassis 14 is formed in a substantially box shape that is horizontally long as a whole so as to almost entirely cover the light guide plate 16, the LED units LU, and the like from the rear side. The rear outer surface of the chassis 14 (surface opposite to the side facing the light guide plate 16) is exposed to the outside on the rear side of the liquid crystal display device 10, and constitutes the rear surface of the liquid crystal display device 10. The chassis 14 is made of a metal such as an aluminum-type material, for example, and is constituted of a bottom plate 14a that is rectangular in a plan view, side walls 14b and 14b that rise from the outer edges of the respective long sides of the bottom plate 14a, and side walls 14c and 14c that rise from the outer edges of the respective short sides of the bottom plate 14a. The space in the chassis 14 between the respective LED substrates 18 is a housing space for the light guide plate 16. On the rear side of the bottom plate 14a, a power source circuit substrate (not shown) that supplies power to the LEDs 17 or the like is attached.

Next, the structure and function of a main component of the present invention, a support member 30, will be described. As shown in FIG. 2, the liquid crystal display device 10 according to the present embodiment has a structure in which the respective support members 30 are disposed alongside the respective edges of the optical members 15. Each of the support members 30 extends along each of the edges of the optical members 15, and has substantially the same length as each of the edges of the optical members 15. Each of the support members 30 has a function to separate the optical members 15 from the liquid crystal panel 11 and individually support them by the first support section 30a and the second support section 30b mentioned later. In the liquid crystal display device 10, by separating the structure of the support member 30 into a structure that supports the liquid crystal panel 11 and a structure that supports the optical members 15, the light that passes through the optical members 15 can be efficiently transmitted to the panel surface of the liquid crystal panel 11, and light leakage can be effectively prevented.

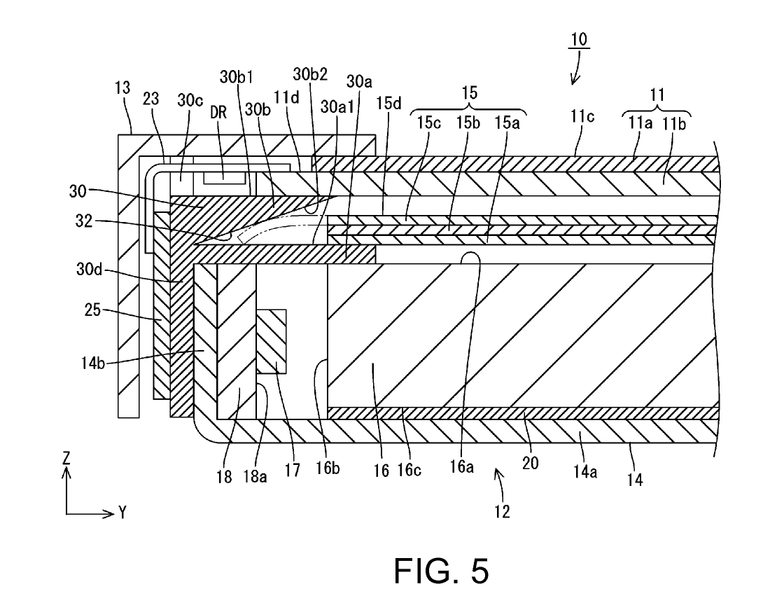

As shown in FIGS. 4 and 5, each support member 30 is formed of the first support section 30a, the second support section 30b, a protrusion 30c, and an abutting portion 30d. The abutting portion 30d has a plate shape that is parallel to the side wall 14b (14c) of the chassis 14, and the long side direction thereof matches the X axis direction, the short side direction thereof matches the Z axis direction, and the thickness direction matches the Y axis direction. The abutting portion 30d abuts the outer side face (face on the opposite side from the side having the LED substrate 18 attached thereto) of the side wall 14b (14c) of the chassis. The first support section 30a extends in a plate shape from the inner face of the abutting portion 30d towards the inside so as to be parallel to the light-emitting surface 16a of the light guide plate 16 (parallel to the display surface 11c of the liquid crystal panel 11). The rear face of the tip of the first support section 30a is in contact with an edge of the light-emitting surface 16a, and presses on the edge of the light-emitting surface 16a. The second support section 30b extends from the inner face of the abutting portion 30d farther towards the front side than the portion where the first support section 30a extends to the inside so as to be parallel to the light-emitting surface 16a of the light guide plate 16 (parallel to the display surface 11c of the liquid crystal panel 11). The protrusion 30c is a portion that protrudes farther towards the front side than the portion where the second support section 30b of the abutting portion 30d extends. The tip of the front side of the protrusion 30c comes into contact with the inner face of the bezel 13 so as to support the bezel 13.

As shown in FIG. 5, the first support section 30a that forms the support member 30 has a surface that is the first support surface 30a1 that supports the optical members 15 by having an edge of the optical members 15 be placed thereon. By having the first support section 30a of the support member 30 be interposed between the light guide plate 16 and the optical members 15, the light guide plate 16 and the optical members 15 are separated. As a result, an effect of diffusing the light emitted from the light-emitting surface 16a of the light guide plate 16 can be obtained, and a good brightness distribution can be maintained. As shown in FIG. 5, the cross-section of the second support section 30b that is a part of the support member 30 is formed so as to have a cross-section having a triangular shape. The surface of the second support section 30b (hereinafter, second support surface 30b1) is a flat face that is parallel to the liquid crystal panel 11, an edge of the liquid crystal panel 11 being placed on the second support surface 30b1 so as to be supported by the second support surface 30b1. In other words, the liquid crystal panel 11 is slightly larger than the optical members 15 in a plan view. As a result, the edges of the liquid crystal panel 11 are located farther outside than the edges of the optical members 15, but with the support member 30, the tip of the second support section 30b is located farther outside than the tip of the first support section 30a, so the edges of the optical members 15 and the edges of the liquid crystal panel 11 can be supported simultaneously. Meanwhile, the rear surface of the second support section 30b (hereinafter, opposite surface 30b2) is an inclined surface that is inclined relative to the second support surface 30b1. More specifically, as shown in a cross-sectional view in FIG. 5, the opposite surface 30b2, is an inclined surface inclined from the front side to the rear side in a direction towards the outside (side farther away from the edges of the liquid crystal panel 11). Because the opposite surface 30b2 has this type of inclined surface, the thickness of the second support section 30b (width in the Z axis direction) becomes larger, the farther away the opposite surface 30b2 is from the edge of the liquid crystal panel 11.

In each of the support members 30, the first support section 30a and the second support section 30b are separated, because the opposite surface 30b2 of the second support section 30b is an inclined surface. As a result, a recess 32 having a tapered shape is formed between the first support section 30a and the second support section 30b. The recess 32 is formed between the opposite surface 30b2 of the second support section 30b and the first support surface 30a1 of the first support section 30a and is open towards the edge of the optical members 15. The liquid crystal display device 10 according to the present embodiment includes the support member 30 having two separate portions, a portion that supports the optical members 15 (first support section 30a) and a portion that supports the liquid crystal panel 11 (second support section 30b), and thus, the liquid crystal panel 11 can be reliably supported while providing the recess 32 in the side of the edge of the optical members 15.

Because the thickness of the second support section 39b increases the farther away the second support section 30b is from the edge of the liquid crystal panel 11, the thickness of the second support section 30b near the boundary between the abutting portion 30d and the second support section 30b is greater in the configuration according to the present embodiment compared to a configuration in which the recess 32 is provided such that the opposite surface 30b2 of the second support section 30b is a flat face parallel to the first support surface 30a1 of the first support section 30a. In other words, compared to a configuration in which the recess 32 has a rectangular shape in a cross-sectional view, the configuration according to the present embodiment is stronger near the boundary between the abutting portion 30d and the second support section 30b. Thus, even if the recess 32 is provided between the first support section 30a and the second support section 30b, the strength of the first support section 30a provided on the front side of the recess 32 can be maintained, and as a result, the strength of the support member 30 can be maintained.

In the liquid crystal display device 10, because the support member 30 has the configuration mentioned above, the recess 32 is provided between the first support section 30a and the second support section 30b where the edge of the optical members 15 can be housed. Here, the two-dot chain line in FIG. 5 indicates the extended portion of a reflective polarizing sheet 15c, which is the frontmost sheet member of the optical members 15, if the edge of the reflective polarizing sheet 15c extends outward due to heat. As mentioned above, among the three sheets that constitute the optical members 15, the reflective polarizing sheet 15c has the greatest thermal expansion coefficient, and thus, the length of the portions of the other two sheet members that extend due to heat is shorter than the reflective polarizing sheet 15c. Thus, in FIG. 5, the portions of the other two sheet members that extend due to heat are not shown. As shown in FIG. 5, in the liquid crystal display device 10, if the edge of the reflective polarizing sheet 15c extends towards the outside due to heat, the extended portion enters the recess 32 from the opening thereof. The tip of the extended portion that entered the recess 32 first comes into contact with the opposite surface 30b2 of the second support section 30b, and next, the extended portion further extends along the opposite surface, which is an inclined surface, while being in contact with the opposite surface, and then the extended portion bends towards the bottom of the recess 32 (first support surface 30a1 side) as it extends further inside the recess 32. In this manner, the portion of the optical members 15 that extends due to heat can be housed inside the recess 32, and the extending of the optical members 15 due to heat can be accommodated without any wrinkles forming in the extended portion (edge of the optical members 15).

If the edge of the optical members 15 extends in a direction away from the center of the optical members 15 in the backlight device 24 according to the present embodiment in the manner described above, the extended portion enters the recess 32 without the extended portion colliding with the support member 30. At this time, because the opposite surface 30b2 of the second support section 30b is an inclined surface, if the extending portion extends further after coming into contact with the inclined surface, then the extending portion is guided farther inside the recess 32 along the inclined surface. As a result, even if the edge of the optical members 15 extends, the extending can be accommodated, and therefore wrinkles can be prevented or suppressed from forming on the edge of the optical members 15. In addition, because the opposite surface 30b2 of the second support section 30b is an inclined surface, the thickness of the first support section 30a becomes greater as the first support section 30a is farther away from the edge of the liquid crystal panel 11, and the strength of the second support section 30b is improved compared to a case in which the recess 32 is formed such that the second support section 30b has an even thickness. As a result, even if the recess 32 is provided between the first support section 30a and the second support section 30b, the strength of the second support section 30b can be maintained. As mentioned above, in a configuration in which the liquid crystal display device 10 according to the present embodiment has the support member 30 that supports the liquid crystal panel 11 and the optical members 15, the extending of the optical members 15 due to heat can be accommodated while maintaining the strength of the support member 30. As a result, wrinkles can be prevented or suppressed from forming in the edges of the optical members 15.

Furthermore, the liquid crystal display device 10 according to the present embodiment has support members 30 respectively disposed on each of the edges (side of each edge of the optical members 15) of the liquid crystal panel 11. By having this type of configuration, the liquid crystal panel 11 and the optical members 15 can be more effectively held by the four support members 30.

The liquid crystal display device 10 according to the present embodiment has a configuration in which the optical members 15 are formed of three sheet members stacked together, and the reflective polarizing sheet 15c, which has the greatest thermal expansion coefficient, is disposed closest to the liquid crystal panel 11. By having this type of configuration, when the edges of the optical members 15 extend due to heat, then among the sheet members forming the optical members 15, the reflective polarizing sheet 15c, which is disposed farthest towards the front surface and has the greatest effect on the display quality due to wrinkles forming therein, comes into contact with the inclined surface (opposite surface 30b2) in the recess 32 first, and thus, the reflective polarizing sheet 15c can be guided towards the end of the recess 32 at an early stage, and the decrease in display quality or the like caused by wrinkles forming in the optical members 15 can be effectively prevented.

The liquid crystal display device 10 according to the present embodiment includes the chassis 14 having side wall 14b and 14c that rise from the outer edges of the chassis 14 towards the display surface 11c of the liquid crystal panel 11. The liquid crystal display device 10 is configured such that the surface of the first support section 30a of the support member 30 opposite to the first support surface 30a1 is supported by the chassis 14 by being in contact with the tip of the side walls 14b and 14c towards the display surface 11c side (front side). By having this type of configuration, the support member 30 can be attached to the chassis 14 of the backlight device 12 in the manufacturing process of the liquid crystal display device 11.

The liquid crystal display device 10 according to the present embodiment has a configuration in which the support member 30 is supported by the chassis 14 by the abutting portion 30d being in contact with the side walls 14b and 14c of the chassis. The support portion 30 is configured such that when the support member 30 is supported by the chassis 14, the support member 30 does not have any portion that extends farther outside than the abutting portion 30d, and the bezel 13 is close to the attaching portion 30d. In the present embodiment, because the support member, which supports the liquid crystal panel 11 and the optical members 15 individually, is configured in this manner, the horizontal dimension (length in the X axis direction) and the vertical dimension (length in the Y axis direction) of the liquid crystal display device 10 do not increase by much as a result of the support member 30, and thus, narrowing of the frame can be achieved.

### Embodiment 2

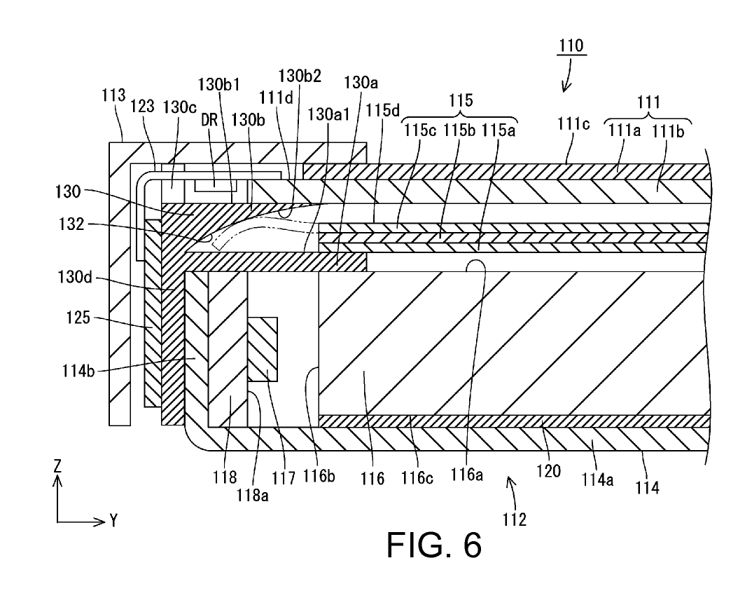

Embodiment 2 will be described with reference to the drawings. In Embodiment 2, the shape of an opposite surface 130b2 (inclined surface) of a second support section 130b of a support member 130 is different from Embodiment 1. Other elements are similar to those of Embodiment 1, and therefore, descriptions of the configurations, the operation, and the effect will be omitted. Parts in FIG. 6 that have 100 added to the reference characters of FIG. 5 are the same as these parts described in Embodiment 1.

As shown in FIG. 6, a liquid crystal display device 110 according to Embodiment 2 includes the support member 130 having the opposite surface 130b2 (inclined surface) of the second support section 130b formed in a curved shape that is recessed towards a second support surface 130b1. With this configuration, as indicated by the two-dot chain line in FIG. 6, a portion of the edge of the optical members 115 that extends due to heat comes into contact with the opposite surface 130b2 (inclined surface) having a curved shape, and thus, the extended portion enters the recess 132 more smoothly compared to the configuration of Embodiment 1 (configuration in which the inclined surface is a flat face). As a result, the liquid crystal display device 110 according to Embodiment 2 can effectively accommodate the extending of the edges of the optical members 115 caused by heat.

### Embodiment 3

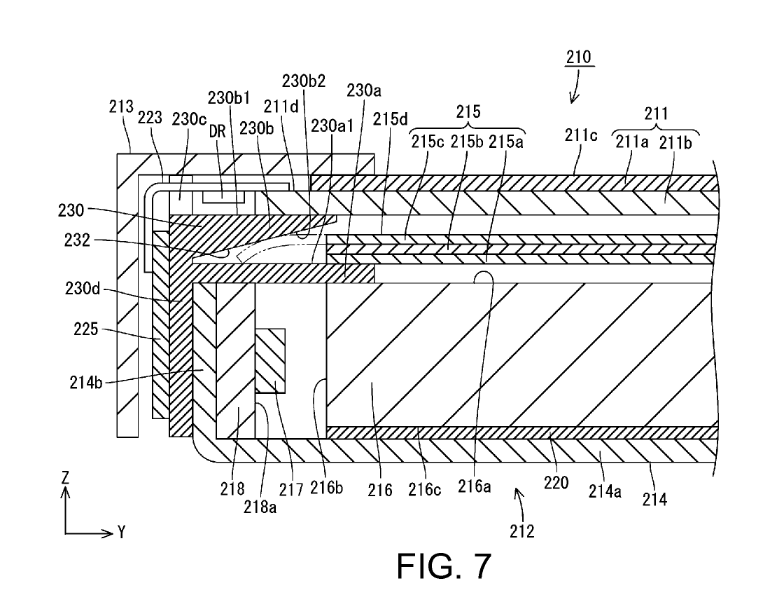

Embodiment 3 will be described with reference to the drawings. In Embodiment 3, the shape of the second support section 230b of the support member 230 is different from Embodiment 1. Other elements are similar to those of Embodiment 1, and therefore, descriptions of the configurations, the operation, and the effect will be omitted. Parts in FIG. 7 that have 200 added to the reference characters of FIG. 7 are the same as these parts described in Embodiment 1.

As shown in FIG. 7, the liquid crystal display device 210 according to Embodiment 3 includes the support member 230 having the opposite surface 230b2 (inclined surface) of the second support section 230b formed of a plurality of flat faces. More specifically, the opposite surface 230b2 has a small first flat face that is formed on the tip of the second support section 230b along a direction (Z axis direction) that is perpendicular to the display surface 211c of the liquid crystal panel 211, an inclined surface that forms a large portion of the opposite surface 230b2 and has a similar shape to that of Embodiment 1, and a small second flat face that is formed on the boundary between the second support section 230b and the abutting portion (end of the recess 232) in a direction (Z axis direction) perpendicular to the display surface 211c of the liquid crystal panel 211. The liquid crystal display device 210 according to Embodiment 3 has a flat face formed on the tip of the second support section 230b, and thus, the tip of the second support section 230b is not pointed. Therefore, the tip of the second support section 230b can be thicker compared to configurations in which the tip of the second support section 230b is pointed. As a result, the strength of the tip of the second support section 230b can be increased compared to configurations in which the tip of the second support section 230b is pointed.

### Embodiment 4

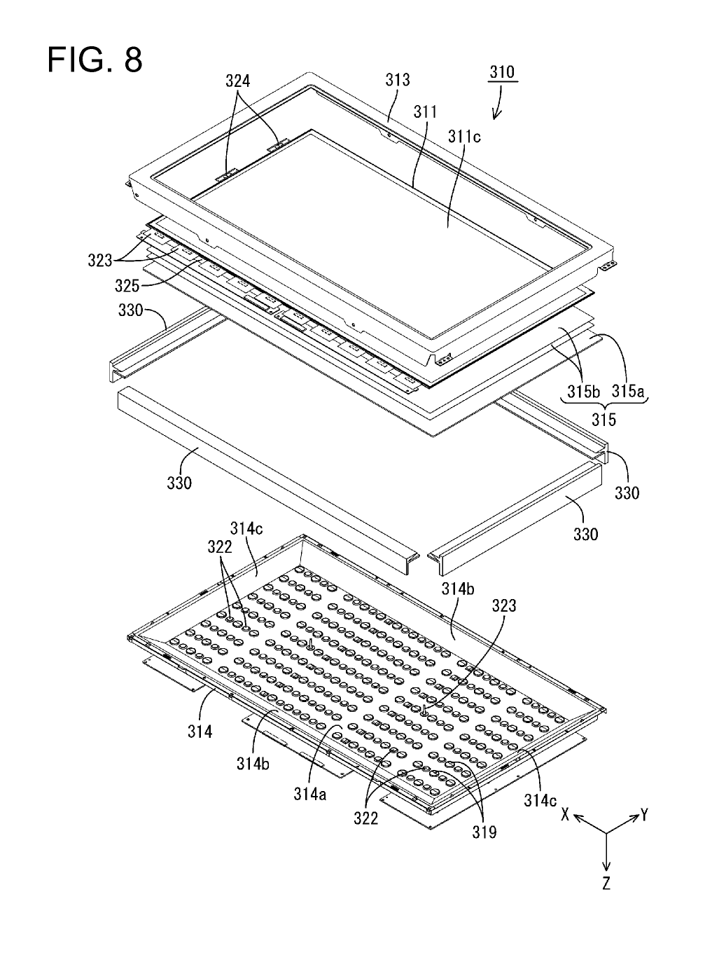

Embodiment 4 will be described with reference to the drawings. The type of a backlight device 312 of Embodiment 4 is different from that of Embodiments 1 to 3. Other elements are similar to those of Embodiment 1, and therefore, descriptions of the configurations, the operation, and the effect will be omitted. As shown in FIG. 8, the backlight device 312 that is a part of a liquid crystal display device 310 of Embodiment 4 does not have a light guide plate, and the backlight device 312 is of a direct-lit type that directly supplies light to the liquid crystal panel 311 from the rear surface thereof. Below, members of Embodiment 4 that are different to those of Embodiment 1 are explained.

The optical members 315 are constituted of a diffusion plate 315a that is disposed on the rear side (LED 317 side, opposite side to the light emitting side), and optical sheets 315b that are disposed on the front side (liquid crystal panel 311 side, light-emitting side). The diffusion plate 315a has a configuration in which a plurality of diffusion particles are dispersed inside a plate-shaped base material made of an almost completely transparent resin having a prescribed thickness, and has the function of diffusing light that is transmitted therethrough. The optical sheets 315b are sheet-shaped and thinner than the diffusion plate 315a, and the two optical sheets 315b are stacked, one on top of the other. Specific types of the optical sheets 315b include a diffusion sheet, a lens sheet, a reflective polarizing sheet, and the like, for example, and it is possible to appropriately choose any of these as the optical sheets 315b. The number and types of optical sheets 315b to be used can be modified as appropriate.

A chassis 314 is made of metal, and as shown in FIGS. 8 to 10, the chassis 314 as a whole has a substantially shallow box shape (substantially shallow tray shape) having an opening on the front side and includes a bottom plate (an example of a plate-shaped portion) having a horizontally-long quadrilateral shape (rectangular-shape) similar to the liquid crystal panel 311, side walls 314b that respectively rise from the outer edges forming the two long sides of the bottom plate 314a towards the front side (light-emitting side), side walls 314c that respectively rise from the outer edges forming the two short sides of the bottom plate 314a towards the front side (light-emitting side), and a receiving plate 314d that extends towards the outside from the edges of the rising portions. In the chassis 314, the longer side direction thereof matches the X axis direction (horizontal direction), and the shorter side direction thereof matches the Y axis direction (vertical direction). On the front side of each receiving plate 314d of the chassis 314, a first support section 330a of the support member 330 can be placed with an extending portion 320c of a reflective sheet 320 being interposed therebetween.

As shown in FIG. 8, the reflective sheet 320 has a size that covers almost the entire inner surface of the chassis 314, and the reflective sheet 320 can cover all of the LED substrates 318 that are aligned within the chassis 314. The reflective sheet 320 allows light in the chassis 314 to be efficiently directed towards the optical members 315. The reflective sheet 320 is constituted of a bottom section 320a extending along the bottom plate 314a of the chassis 314 and having a size large enough to cover a large portion of the bottom plate 314a, four rising portions 320b that rise towards the front from the respective outer edges of the bottom plate 314a and that are inclined in relation to the bottom section 320a, and extension portions 320c that extend towards the outside from the outer edges of the rising portions 320c and that are placed on the receiving plate 314d of the chassis 314.

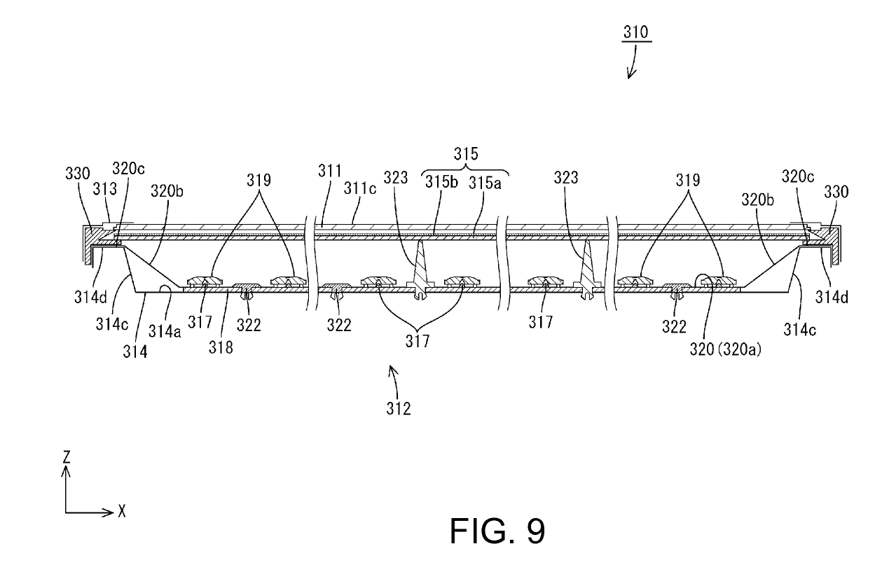

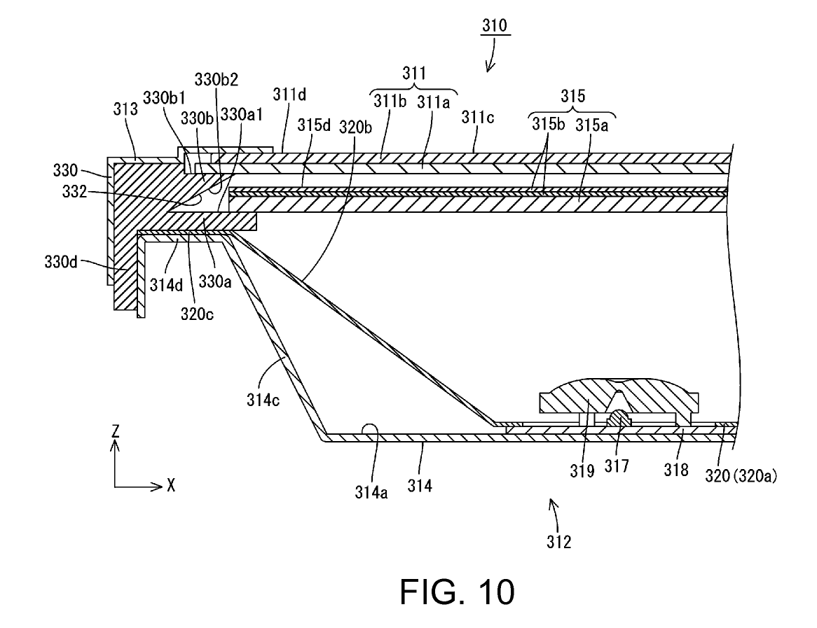

As shown in FIGS. 9 and 10, the LED substrate 318 has a base member having a horizontally-long rectangular shape in a plan view, and the chassis 314 houses the LED substrate 318, which extends along the bottom plate 314a, the long side direction matching the X axis direction and the short side direction matching the Y axis direction. Of the plate surfaces of the base member of the LED substrate 318, a surface facing the front side (surface facing the optical members 315) has the LEDs 317 mounted thereon. The mounted LEDs 317 are disposed such that the light-emitting surfaces face the optical members 315 (liquid crystal panel 311) and such that the optical axis thereof matches the Z axis direction, or in other words, the direction perpendicular to the display screen of the liquid crystal panel 311. On the LED substrate 318, a plurality of LEDs 317 are aligned in a straight line along the long side direction (X axis direction), and wiring patterns (not shown) that connect to the LEDs 317 in a row are formed. The pitch at which the respective LEDs 317 are arranged is substantially constant, which means that the respective LEDs 317 are arranged at substantially even intervals in the X axis direction. A diffusion lens 319 is disposed on the front side of each LED 317. The diffusion lenses 319 have a prescribed thickness and are formed in a substantially circular shape in a plan view and are attached to the LED substrate 318 so as to individually cover each LED 317 from the front side. In other words, the diffusion lenses 319 are attached so as to overlap each of the LEDs 317 in a plan view.

First substrate holding members 322 and second substrate holding members 323 will be explained. The first substrate holding member 322 and the second substrate holding member 323 are formed of a synthetic resin such as polycarbonate, and the surface thereof is white with excellent light-reflecting characteristics. As shown in FIG. 8, the first substrate holding members 322 have a substantially circular shape in a plan view from the front side, and can at least sandwich the LED substrate 318 with the bottom plate 314a of the chassis 314. The first substrate holding members 322 hold the LED substrate 318 with this type of configuration. Meanwhile, as shown in FIG. 8, the second substrate holding member 323 has a pin shape that protrudes towards the front from a member that has a similar shape and structure to the first substrate holding member 322. Having this type of structure, together with the support member 330, the second substrate holding member 323 can support the optical members 315 (diffusion plate 315a, to be more precise) from the rear side.

As shown in FIG. 8, in Embodiment 4, the support member 330 is formed of the first support section 330a, a second support section 330b, and an abutting portion 330d. In other words, unlike the support member 30 of Embodiment 1, the configuration does not have a protrusion. Among these, the abutting portion 330d comes into contact with a portion of the chassis 314 that bends towards the rear side from the end of the receiving plate 314d, and an inner surface of the bezel 313. In the configuration of the support member 330, a surface on the side of the first support section 330a opposite to a first support surface 330a1 is placed on the receiving plate 314d of the chassis 314 while sandwiching the extended portion 320c of the reflective sheet 320 therewith. As a result, the support member 330 is supported by the chassis 314. Meanwhile, a small level difference protruding towards the front side is provided on the outer side of a second support surface 330b1 of the second support section 330b. The edge of the liquid crystal panel 311 is placed on the inner portion of the second support surface 330b1, thereby supporting the liquid crystal panel 311, and the outer portion of the second support surface 330b1 (portion that forms the level difference and protrudes towards the front side) is in contact with the inner surface of the bezel 313 and supports the bezel 313. Other configurations and functions are similar to those of the support member 330 of Embodiment 1. Even if the configuration has a direct-lit type backlight device 312 similar to that of the liquid crystal display device 310 according to Embodiment 3, the support member 330 that supports the liquid crystal panel 311 and the optical members 315 individually can be provided. In addition, as shown in FIG. 10, by providing a recess 332 having a similar shape to the support member 330 of Embodiment 1 between the first support section 330a and the second support section 330b of the support member 330, the strength of the second support section 330b of the support member 330 can be maintained while the extending of the optical members 315 due to heat can be accommodated.

Modification examples of the respective embodiments above will be described below.

(1) In the respective embodiments above, an example in which the support member has an abutting portion in addition to the first support section and the second support section is shown, but as long as the support member has a first support section and a second support section, the other portions are not limited to this configuration.

(2) Besides what was described in the respective embodiments above, the shape of the recess of the support member can be appropriately modified.

(3) In the respective embodiments above, a liquid crystal display device using a liquid crystal panel as a display panel was shown as an example, but the present invention is also applicable to a display device that uses another type of display panel.

(4) In the respective embodiments above, a television receiver that includes a tuner was shown as an example, but the present invention is also applicable to a display device without a tuner.

Embodiments of the present invention were described above in detail, but these are only examples, and do not limit the scope defined by the claims. The technical scope defined by the claims includes various modifications of the specific examples described above.

Also, the technical elements described in the present specification or shown in the drawings realize technical utility on their own or through a combination of various technical elements, and are not limited to the combinations defined by the claims at the time of filing. Also, the techniques described in the present specification or shown in the drawings can accomplish a plurality of objects simultaneously, and each one of the objects on its own has technical utility.

### DESCRIPTION OF REFERENCE CHARACTERS

TV television receiver
Ca, Cb cabinet
T tuner
S stand
10, 110, 210, 310 liquid crystal display device
11, 111, 211, 311 liquid crystal panel
12, 112, 212, 312 backlight device
13, 113, 213, 313 bezel
14, 114, 214, 314 chassis
15, 115, 215, 315 optical member
16, 116, 216 light guide plate
17, 117, 217, 317 LED
18, 118, 218, 318 LED substrate
20, 120, 220, 320 reflective sheet
20a, 120a, 220a light-receiving face
20b, 120b, 220b light-emitting surface
22, 122, 222, 322 chassis
30, 130, 230, 330 support member
30a, 130a, 230a, 330a first support section
30b, 130b, 230b, 330b second support section
32, 132, 232, 332 recess

1. A display device, comprising:
a light source;
a display panel that performs display in a display surface thereof using light from the light source;
an optical member having a sheet shape disposed behind the display panel opposite to the display surface thereof;
a chassis that at least has a plate-shaped portion and that is disposed behind the optical member; and
a support member that supports the display panel and the optical member, the support member including a first support section having a first support surface that supports an edge of the optical member from behind, a second support section that is disposed closer to the display panel than the first support section, the second support section having a second support surface that supports an edge of the display panel from behind, and a recess that is provided between the first support section and the second support section, the recess being formed between the first support surface of the first support section and an opposite surface that is opposite to the second support surface so that an edge of the optical member can enter the recess,
wherein the opposite surface of the second support section is an inclined surface that is inclined with respect to the second support surface such that a thickness of the second support section increases as a distance from the edge of the display panel increases.

2. The display device according to claim 1, wherein the inclined surface of the second support section has a curved shape that is recessed towards the second support surface.

3. The display device according to claim 1, wherein a small flat surface is formed on a tip of the second support section along a direction perpendicular to the display surface of the display panel.

4. The display device according to claim 1,
wherein the display panel and the optical member respectively have a rectangular shape in a plan view, and
wherein the support member is at least provided on each side of prescribed two edges of the optical member opposing each other.

5. The display device according to claim 4, wherein the support member is disposed on each side of edges of the display panel.

6. The display device according to claim 4, wherein the display panel is slightly larger than the optical member in a plan view.

7. The display device according to claim 1,
wherein the optical member includes a plurality of sheet members stacked one on top of another, and
wherein a sheet member having a greatest thermal expansion coefficient among the plurality of sheet members is disposed closest to the display panel.

8. The display device according to claim 1,
wherein the chassis has a side wall that rises from an edge of the chassis towards the display surface, and
wherein the support member is supported by the chassis by a surface of the first support section opposite to the first support surface being in contact with a tip of said side wall towards the display surface.

9. The display device according to claim 1, wherein the display panel is a liquid crystal panel having liquid crystal.

10. A television receiver, comprising the display device according to claim 1.
